(19) United States
(12) Patent Application Publication
(10) Pub. No.: US 2013/0019746 A1
(43) Pub. Date: Jan. 24, 2013

(54) HYDRAULIC ACCUMULATOR AS WELL AS A METHOD FOR ASCERTAINING A STATE OF CHARGE OF A HYDRAULIC ACCUMULATOR

(71) Applicant: Ralph Engelberg, Ditzingen (DE)

(72) Inventor: Ralph Engelberg, Ditzingen (DE)

(21) Appl. No.: 13/574,202

(22) PCT Filed: Jan. 3, 2011
(86) PCT No.: PCT/EP2011/050007

§ 371 Date: Oct. 4, 2012

(30) Foreign Application Priority Data
Jan. 28, 2010 (DE) 102010001310.2

(51) Int. Cl. F15B 1/04; G01L 7/00

(52) U.S. Cl. 92/130 R; 73/700

(57) ABSTRACT

A hydraulic accumulator includes: a pressure vessel; a hose which is situated within the pressure vessel, for receiving a first medium; a gap, which is formed between the pressure vessel and the hose, for receiving a second medium; and at least one connection for supplying and discharging the first or the second medium under pressure into or out of the hose or the gap, the supply of the first medium resulting in the compression of the second medium.

### BACKGROUND INFORMATION

1. Field of the Invention

The present invention relates to a hydraulic accumulator as well as a method for ascertaining a state of charge of a hydraulic accumulator.

2. Description of the Related Art

Hydraulic accumulators are typically used to store large amounts of energy. In hydraulic hybrid vehicles, hydraulic accumulators are, for example, used to store the energy which is, for example, generated when the wheels are braked and to release the energy which is, for example, needed when the vehicle is accelerated. A hydraulic accumulator of this type is described in published German patent application document DE 10 2006 060 078 A1, for example.

Hydraulic accumulators which have an accumulator bladder are known, in particular, from the related art. The bladder is usually made of rubber and provides for a separation between a gas and a hydraulic fluid in the hydraulic accumulator. Hydraulic accumulators of this type are usually situated perpendicularly, i.e., the pressure vessel receiving the hydraulic fluid, the gas, and the accumulator bladder extends essentially perpendicularly to the ground.

### BRIEF SUMMARY OF THE INVENTION

The hydraulic accumulator of the present invention offers the advantage over the conventional approaches that a hose is easily manufacturable. Furthermore, a hydraulic accumulator of this type is scalable using only little effort, since the length of the hose is easily adjustable. Furthermore, hoses may generally be folded in a predictable manner if they are held horizontally, i.e., the hose extends essentially in parallel to the ground. It is true that in the long-term folding bears the risk of damaging the hose. Since, however, the folding is predictable, the hose may be laid out accordingly to avoid such damage. The hydraulic accumulator according to the present invention and its hose may thus also be operated horizontally.

The method of the present invention has the advantage over the conventional approaches that the state of charge of a hydraulic accumulator may be ascertained in a simple manner.

### BRIEF DESCRIPTION OF THE DRAWINGS

Exemplary embodiments of the present invention are illustrated in the drawing and explained in greater detail in the description that follows.

FIG. 1 shows a hydraulic accumulator according to one exemplary embodiment of the present invention in a longitudinal sectional view.

FIG. 2 shows a section A-A from FIG. 1.

FIG. 3 shows a variation of FIG. 2.

FIG. 4 shows a variation of FIG. 3.

FIG. 5 shows a diagram which illustrates a charge characteristic of the hydraulic accumulator according to FIG. 1.

### DETAILED DESCRIPTION OF THE INVENTION

In the figures, identical reference numerals identify identical components or components having an identical function, unless otherwise indicated.

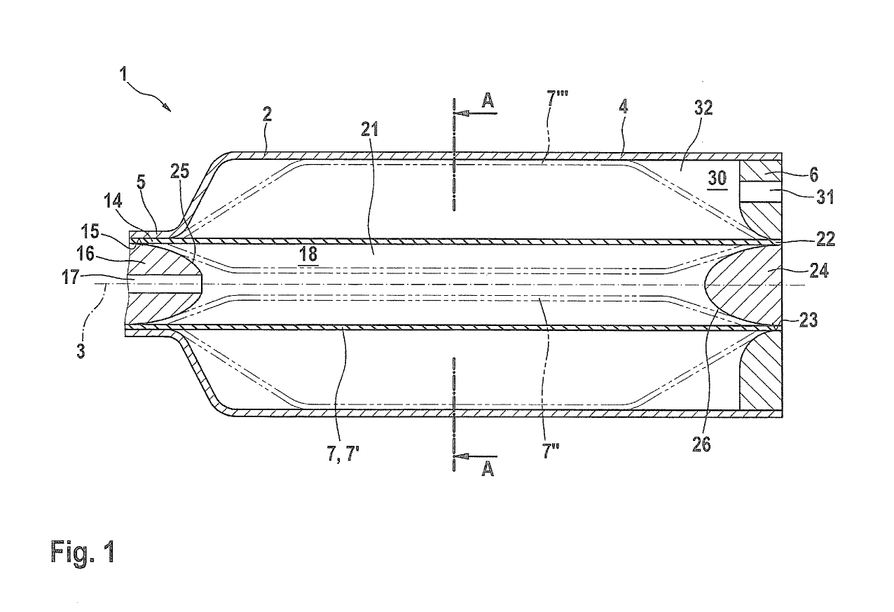

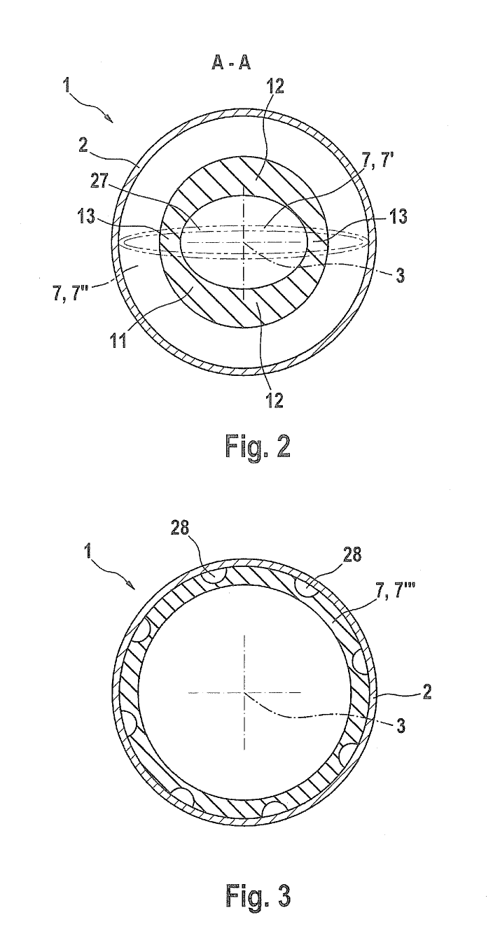

FIG. 1 shows a hydraulic accumulator 1 according to one exemplary embodiment of the present invention in a longitudinal sectional view. FIG. 2 shows a section A-A from FIG. 1.

The hydraulic accumulator has a pressure vessel 2. The latter is dimensionally stable and for this purpose is made of steel, for example. The pressure vessel has a base body 4 which extends along a longitudinal axis 3 and has an essentially annular cross section (see FIG. 2). Base body 4 has a neck 5 at its one end. Base body 4 is closed by a base plate 6 at its opposite end. Another base plate could also be provided instead of neck 5.

A hose 7 is situated within pressure vessel 2. Hose 7 is made of a flexible and elastic material such as rubber. The elasticity of hose 7 may be advantageously used to influence the charge characteristic of hydraulic accumulator 1, as will be described later.

Preferably, hose 7 is produced with the aid of extrusion. In this way, hose 7 may be easily manufactured in any desirable length so that longer or shorter hydraulic accumulators 1 may be built without any problems.

Hose 7 has in its filled state 7′, shown as a solid line in FIG. 1, a fundamentally annular cross section 11, as illustrated in FIG. 2. According to the present exemplary embodiment, cross section 11 is, however, thicker at diametrically opposed points 12 and thinner at diametrically opposed points 13 in deviation from the annular shape.

One end 14 of hose 7 extends through an opening 15 formed by neck 5 of pressure vessel 2. A plug element 16 is pressed into end 14 of hose 7 so that plug element 16 seals end 14 of hose 7 internally and also seals end 14 of hose 7 externally against opening 15 in neck 5 of pressure vessel 2. Plug element 16 has a connection 17 with the aid of which a first medium 18, e.g., a hydraulic fluid, may be supplied to interior 21 of hose 7. Furthermore, hydraulic fluid 18 may be discharged again from interior 21 with the aid of connection 17.

End 22 of hose 7 which is opposite to end 14 extends through an opening 23 in base plate 6 of pressure vessel 2. Another plug element 24 is pressed into end 22 of hose 7 so that this plug element seals end 22 of hose 7 internally and also seals end 22 externally against opening 23.

Plug elements 16 and 24 do not have to be pressed into ends 14 and 22 of hose 7, respectively. Alternatively, end 14 may be sealingly glued or otherwise connected to plug element 16 and opening 15, and likewise end 22 to plug element 24 and opening 23.

Preferably, plug elements 16 and 24 each have a rounding 25 and 26, respectively, which bulges into interior 21 of hose 7. Roundings 25 and 26 are supposed to prevent damage to hose 7 or abrasion thereof in its empty state labeled with reference numeral 7″ in FIG. 1. Roundings 25 and 26 preferably each have an approximately parabolic shape. Plugs 16, 24 are additionally fixed in the axial direction (not shown); the fixing may be necessary due to the high internal pressure.

Empty state 7″ of hose 7 is also illustrated in FIG. 2, hose 7 having an essentially oval shape of cross section 27. To reliably achieve this type of folding of hose 7 to obtain the illustrated oval shape of cross section 27 in its empty state 7″, hose 7 is designed to have the previously described thicker and thinner points 12 and 13, respectively.

Base plate 6 of pressure vessel 2 has a connection 31. Connection 31 allows a second medium 30, for example a gas, to be supplied to and discharged from a gap 32 formed between pressure vessel 2 and hose 7. In the present case, gap 32 is designed as an annular space and extends along longitudinal axis 3.

To obtain a desired charge characteristic, an additional pressure vessel for gas (not illustrated) may be connected to connection 31 of pressure vessel 2.

Hydraulic accumulator 1 according to FIG. 3 differentiates itself from that according to FIGS. 1 and 2 solely in that hose 7 is designed to have external longitudinal grooves 28. FIG. 3 shows here an elastically stretched state 7″′ of hose 7, which is also shown in FIG. 1. Longitudinal grooves 28 and hose 7 are illustrated exaggeratedly large and thick for the sake of better understanding.

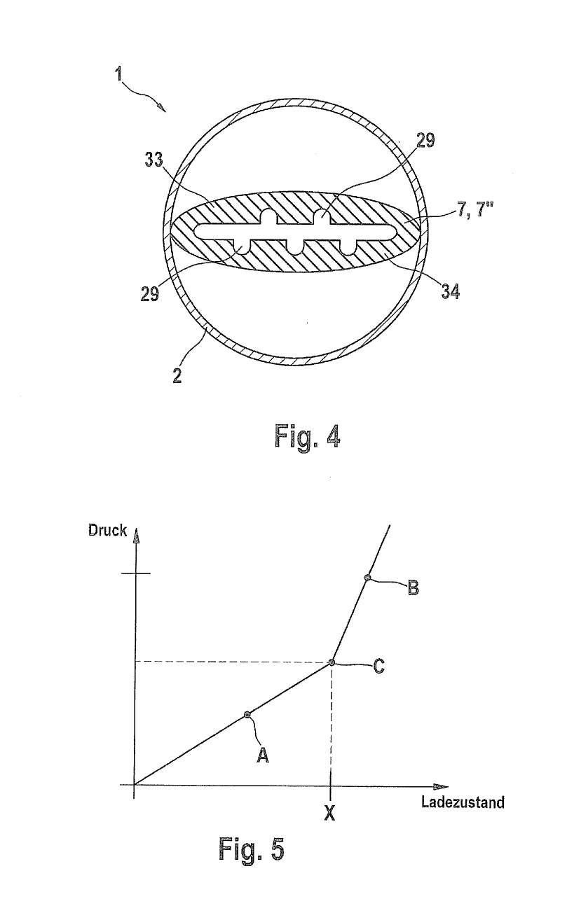

Hydraulic accumulator 1 according to FIG. 4 differentiates itself from that according to FIGS. 1 and 2 solely in that hose 7 is designed to have internal longitudinal grooves 29. FIG. 4 shows here empty state 7″ of hose 7, which is also shown in FIG. 1. Longitudinal grooves 29 and hose 7 are illustrated exaggeratedly large and thick for the sake of better understanding.

Following the previous, essentially constructive description of hydraulic accumulator 1, its mode of operation will now be described.

The energy generated when the motor vehicle is braked may, for example, be used to pump hydraulic fluid 18 under pressure through connection 17 of hydraulic accumulator 1 into interior 21 of hose 7. During this process, hose 7 expands from its empty state 7″ to its filled state 7′ (see FIG. 1).

Internal longitudinal grooves 29 in hose 7 are used here to prevent opposite hose walls 33 and 34 from sticking together and to thus ensure a reliable filling of hose 7.

While hose 7 expands, gas 30 located in gap 32 is compressed.

In a diagram, FIG. 5 shows a charge characteristic of hydraulic accumulator 1. “Charge characteristic” is understood in the present case as the characteristic of the pressure in hydraulic fluid 18 or in gas 30 as a function of the state of charge, i.e., as a function of the degree of filling of hose 7. As is apparent from FIG. 5, an increasing pressure in hydraulic fluid 18 is necessary to further compress the gas in gap 32. The pressure characteristic between empty state 7″ and filled state 7′ is labeled with reference symbol A in FIG. 5. If the supply of hydraulic fluid is continued; hose 7 must stretch elastically in order to deform from its filled state 7′ to its elastically stretched state 7″′. The pressure characteristic as a function of the state of charge between filled state 7′ of hose 7 and elastically stretched state 7″′ is labeled with reference symbol B in FIG. 5. This pressure characteristic B may be influenced by appropriately selecting the elasticity of hose 7, for example, by designing the hose from a different material and/or to have a thicker or thinner wall.

The pressure change in a transition area “C” (and/or its first mathematical derivative) between lines A and B may be detected in order to determine that a state of charge X has been reached. State of charge X corresponds to filled state 7′ of hose 7. The pressure change is advantageously measured with increasing charge, i.e., filling, or discharge, i.e., emptying, of hydraulic accumulator 1 and compared to a predetermined pressure change which is provided for state of charge X.

If hose 7 is completely filled in its elastically stretched state 7′″ the hose is in contact with the interior walls of pressure vessel 2, as illustrated in FIG. 3. Now, in order to prevent gas blankets from forming between hose 7 and pressure vessel 2, the hose has longitudinal grooves 28 so that gas 30 may be distributed evenly along longitudinal axis 3 of hose 7. Of course, it is also conceivable to additionally provide transversal grooves.

Although the present invention was described here concretely with reference to exemplary embodiments, it is not limited thereto, but may be modified in various ways.

In particular, hydraulic fluid 18 may also be provided in gap 32, and gas 30 in interior 21. In this case, hydraulic fluid 18 would be supplied and discharged via connection 31, for example. The other pressure vessel (not illustrated) for gas (also referred to as secondary gas volume) could then be connected to connection 17.

Furthermore, plug element 16 and pressure vessel 2 could be made as one piece and/or base plate 6 and plug 24 could be made as one piece.

1-10. (canceled)

11. A hydraulic accumulator, including:
a pressure vessel;
a hose situated within the pressure vessel and receiving a first medium, wherein a gap is formed between the pressure vessel and the hose for receiving a second medium; and
at least one connection for supplying and discharging one of the first medium or the second medium under pressure one of into or out of one of the hose or the gap, wherein supplying of the first medium results in a compression of the second medium.

12. The hydraulic accumulator as recited in claim 11, wherein the hose is elastic for changing a charge characteristic of the hydraulic accumulator.

13. The hydraulic accumulator as recited in claim 12, wherein the hose is clamped at both ends.

14. The hydraulic accumulator as recited in claim 12, wherein at least one of (i) a rounded plug element extends sealingly into one end of the hose, and (ii) a rounded plug element sealingly clamps the one end of the hose against an opening in the pressure vessel.

15. The hydraulic accumulator as recited in claim 12, wherein the hose has an oval cross section in the empty state.

16. The hydraulic accumulator as recited in claim 15, wherein the hose has, in the empty state, at least one of a wall thickening and a wall thinning at a predetermined position of the hose.

17. The hydraulic accumulator as recited in claim 15, wherein the hose has external longitudinal grooves.

18. The hydraulic accumulator as recited in claim 17, wherein the hose has internal longitudinal grooves.

19. A method for ascertaining a state of charge of a hydraulic accumulator having a pressure vessel, a hose situated within the pressure vessel and receiving a first medium, wherein a gap is formed between the pressure vessel and the hose for receiving a second medium, and at least one connection for supplying and discharging one of the first medium or the second medium under pressure one of into or out of one of the hose or the gap, wherein supplying of the first medium results in a compression of the second medium, the method comprising:
measuring a first pressure change in at least one of the first medium and the second medium;
comparing the measured first pressure change to a predetermined second pressure change which is associated with a transition between an elastic and a non-elastic deformation of the hose; and
determining that a state of charge corresponding to the second pressure change is achieved when the first pressure change is essentially identical to the second pressure change.
